(19) United States
(12) Patent Application Publication
(10) Pub. No.: US 2007/0230794 A1
(43) Pub. Date: Oct. 4, 2007

(54) Real-time automatic facial feature replacement

(75) Inventors: Paul McAlpine, Dublin, CA (US); Ravi Punati, San Ramon, CA (US); Ken Erbes, San Carlos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 11/398,506

(22) Filed: Apr. 4, 2006

(51) Int. Cl. G06K 9/46

(52) U.S. Cl. 382/190

(57) ABSTRACT

A method for modifying selected regions of a target image based on selected regions of a source image. In one embodiment, facial features are detected in a video image from a webcam. One or more of those facial features are selected and superimposed on the target image. Resizing and alpha blending techniques are used to blend the source portions into the target images. For example, this can produce fun effects such as moving the eyes and lips of an image of Mona Lisa.

### CROSS-REFERENCES TO RELATED APPLICATIONS

Related applications of the same assignee are patent application Ser. No. 11/183,179, entitled “Facial Features-Localized and Global Real-Time Video Morphing”, filed on Jul. 14, 2005; and patent application Ser. No. 10/767,132, entitled “Use of Multimedia Data for Emoticons In Instant Messaging”, filed on Jan. 28, 2004, Publication No. 2005/0163379, which are hereby incorporated herein in their entirety.

### BACKGROUND OF THE INVENTION

The present invention relates to modifying an image in real time, in particular varying features of an image of a person by moving lips and eyes.

Software has existed for some time to modify images, such as a person's face. U.S. Pat. No. 5,825,941 is an example of software allowing a patient to see the effects of proposed plastic surgery before it is done. Other software allows users to modify static pictures that can be saved and printed, such as by varying the features of the face or morphing two faces together. US Published Application No. 20050026685 shows a system for morphing video game characters. US Published Application No. 20040201666 shows using user voice or other inputs to modify a virtual character.

A variety of applications are directed to modifying avatars for use with instant messaging. These applications allow a user to personalize the avatar image that is the representation of the user. For example, U.S. Published Application No. 20030043153 shows determining facial expressions from a webcam video feed and mapping those expressions to an avatar. An animation vector is mapped to a target mix vector.

Jay Leno does a routine where his mouth moves on the image of a famous person. This is done by aligning a video of Jay talking with the image, and mixing the two to superimpose his lips over the image. Jay sits in front of the camera at just the right position to do this.

U.S. Pat. No. 6,580,811 describes detecting facial features in a live video and using those to animate an avatar. The animated facial image may be based on a photorealistic model of the person, a cartoon character or a face completely unrelated to the user. The avatar is animated using one of a number of common techniques, as described in columns 12-13: (1) key framing and geometric interpolation, (2) direct parameterization, (3) pseudo-muscle models, (4) muscle-based models, (5) 2D and 3D morphing, and (6) control points and finite element models.

Seiko Epson U.S. Pat. No. 5,850,463 describes varying the expression of a synthesized facial image by changing coordinate values to slightly move a particular point in one or more feature areas, such as the eyes, nose, eyebrows, or mouth. An expression can be changed by defining expression data that describes which points in the facial image are moved and in what direction (see col. 17, lines 20-33).

Taarna Studios U.S. Pat. No. 6,163,322 describes a method for animating a synthetic body part using a database of basic postures.

### BRIEF SUMMARY OF THE INVENTION

The present invention provides a method for modifying selected regions of a target image based on selected regions of a source image. In one embodiment, facial features are detected in a video image from a webcam. One or more of those facial features are selected and superimposed on the target image. Resizing and alpha blending techniques are used to blend the source portions into the target images. For example, this can produce fun effects such as moving the eyes and lips of an image of Mona Lisa.

In one embodiment, a video feed from a web cam, such as a USB video feed, is provided through a camera driver to feature recognition software. The image of a person (source image) in the video is located, and then selected features are located. Feature recognition software also locates the features in the target image. The locations of the features for both images are provided to a separate feature replacement software module. The feature replacement software module performs resizing and alpha blending, then performs the feature replacement by substituting, from the source image into the target image, a group of pixels corresponding to the features.

### BRIEF DESCRIPTION OF THE DRAWINGS

FIG. 1 is a diagram illustrating the system and user layers of software in an embodiment of a system incorporating the feature replacement features of the present invention.

FIG. 2 is a block diagram of an embodiment of a system incorporating the feature replacement features of the present invention.

FIGS. 3A and 3B are diagrams of a hovering dialog box and drop down menu in one embodiment of the invention.

FIG. 4 is a diagram of an embodiment of a user interface screen for selecting the feature replacement.

FIG. 5 is a screen shot of an embodiment of an instant messenger application incorporating the facial feature replacement feature of the invention.

FIGS. 6A-6D are screen shots illustrating the modification of the eyes and mouth of Mona Lisa according to an embodiment of the invention.

FIG. 7 is a flowchart of an embodiment of the invention.

### DETAILED DESCRIPTION OF THE INVENTION

### System

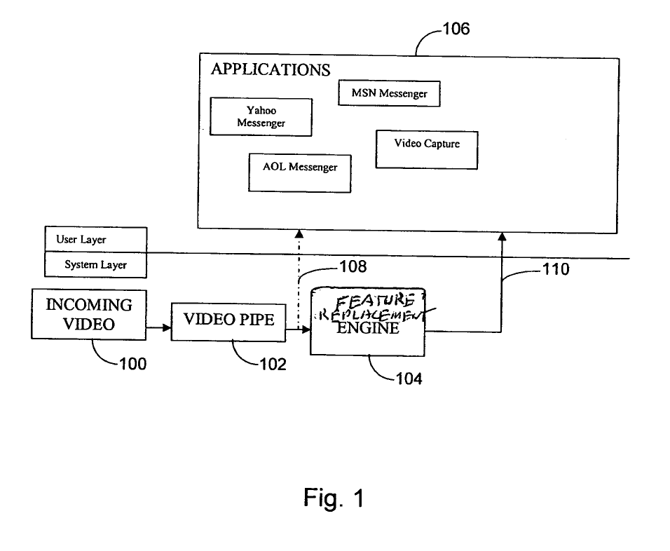

FIG. 1 illustrates the operation of one embodiment of the invention. Incoming video 100 is provided to a video pipe 102 which is received by the feature replacement engine 104 of the present invention. The video pipe can be provided directly to applications 106 as indicated by arrow 108, or can be provided to the feature replacement engine. The feature replacement engine provides a modified video pipe to the applications as indicated by arrow 110.

In one embodiment, modified video pipe 110 is actually a still image (further referred to as ‘background image’ or ‘target image’) with certain features moving, such as the eyes and mouth. For example, a background image of Mona Lisa could be provided. Certain facial features of Mona Lisa (for example: eyes and mouth) could then be replaced by their moving counterparts automatically retrieved from the video stream (further referred to as ‘foreground video’ or ‘source video’) obtained from USB webcam (that webcam would be pointed onto a face of an arbitrary speaker).

In another embodiment, modified video pipe 110 is actually a video containing a face or faces incoming from an arbitrary source (further referred to as ‘background video’ or ‘target video’) with certain facial features on that background video replaced by their counterparts (also moving) from video (also containing face) incoming from a different source (for example—an USB webcam). The latter video is further referred to as ‘foreground video’. The facial features in the background and the foreground videos are then automatically localized. Once this is achieved, the facial features in the background video are replaced by the facial features from the foreground video.

For example, the user is watching a DVD movie with James Bond. The user has a webcam pointed onto his face. The user is free to move around (no requirement to hold still at a certain position as the feature tracking engine tracks the feature in the field of view). The facial features of James Bond localized on the DVD video frame are replaced by facial features of the user (the latter automatically retrieved from the webcam video stream). The user's facial features are properly sized, rotated and alpha-blended to provide a realistic and believable result.

In another embodiment, the entire face from the background image or the background video could be replaced by a face from the foreground video.

The modified video pipe can be used by any application that uses image input. This includes instant messaging applications (MSN Messenger, Yahoo Messenger, AOL messenger, etc.) as well as video capture applications (when—for example—an artist is capturing the video to the disk). This means that the feature replacement can be applied before the video is captured to the disk and stored or before it is sent to the interlocutor on the other side of the communication channel. This is because the feature replacement engine is integrated into the system-level part of the software, which makes it transparent to the applications using the video stream that lay above the system layer at the user layer. In this way the present invention is generic—i.e. it can coexist with any video application and modify its input according to the settings on quick assistant.

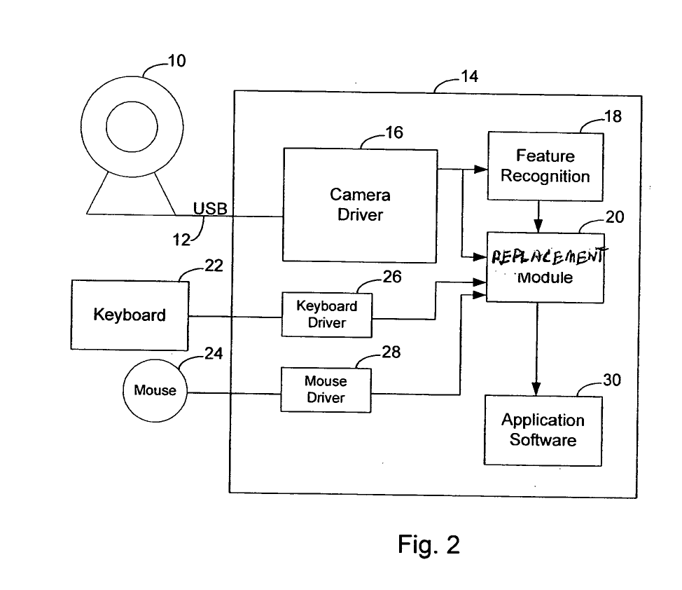

FIG. 2 is a block diagram of an embodiment of a system incorporating the feature replacement of the present invention. A web cam 10 is connected through a USB bus 12 to a computer 14. The USB bus 12 acts as a video feed from the camera to the computer. Alternately, a wireless USB feed could be provided, or any other bus or interface could be used to provide the video. Additionally, a camera, other than the web cam, could be used.

Computer 14 includes a camera driver 16 which receives the live video and provides it to feature recognition software module 18. Feature recognition module 18 could be any software which extracts information regarding facial features from a video image, such as the software produced by Neven Vision, a machine vision technology company with offices in Santa Monica, Calif.

The detected information regarding facial features is provided to a feature replacement module 20. The feature replacement module responds to user inputs to select facial features, determine the type of feature replacement, and apply the feature replacement. The user input can be provided through any peripheral, such as keyboard 22 or mouse 24 with associated keyboard driver 26 and mouse driver 28. After the feature replacement has been applied, the video feed or image is provided to application software 30. The application software could be an instant messenger application, a video conferencing application, or any other application which uses video or images. In one embodiment, the delay caused by the use of the feature recognition and feature replacement software is less than one frame of video.

The feature replacement module contains a sizing module and alpha blending module. The sizing module adjusts the size of the features of the user captured with the camera (the source image) to the size of the corresponding feature to be replaced in the target image. The image is then alpha blended, to adjust the color of the pixels near the edge of the source image block to the pixels surrounding the feature to be replaced on the target image. Such alpha blending techniques are well known to those of skill in the art. In addition, the angle of the replacement feature and its luminance can also be adjusted to match or blend it into the target image.

### Feature Replacement Quick Assistant

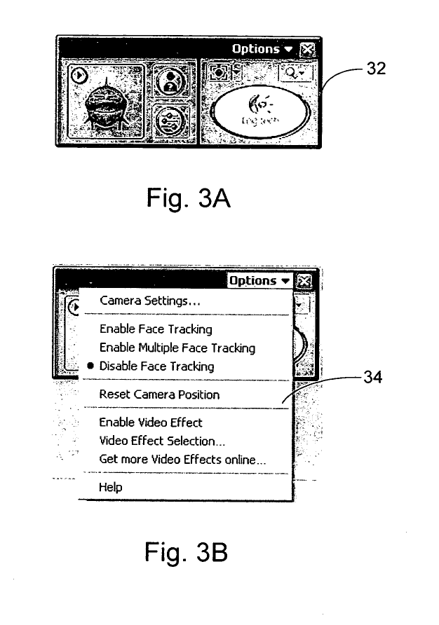

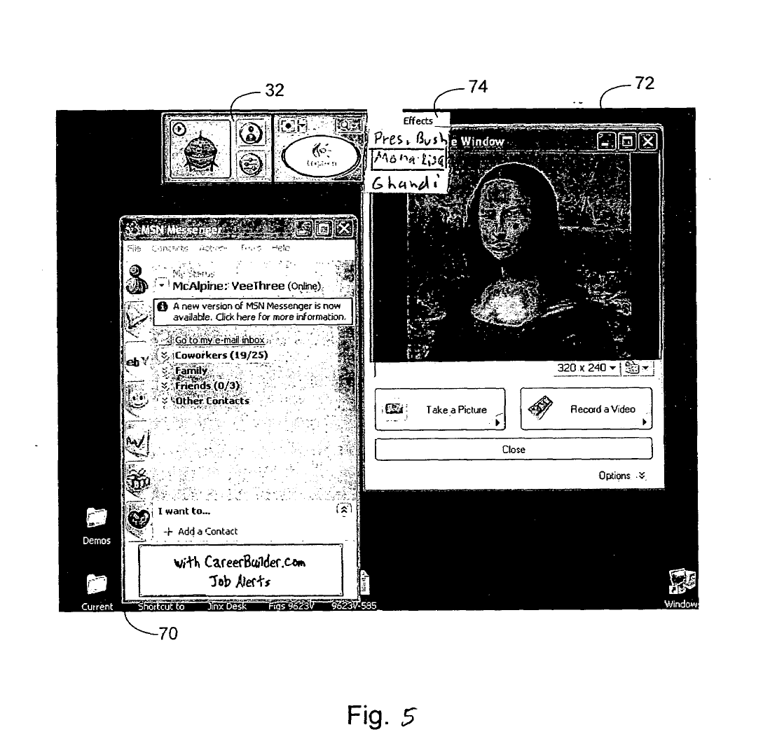

FIG. 3A shows a hovering dialog box 32, which is a quick assistant that will open and appear on the screen when live video is requested. This automatic activation is accomplished by the camera or video driver software, which detects when a request is made for a video feed from an application, such as an instant messenger application. The quick assistant will appear close to the window of the program that called for the live video, so it will appear as if it were part of that application. An example for instant messaging is shown in FIG. 5. This provides an advantage in allowing the feature replacement application to work with third-party applications that use a video feed and need not be modified to accommodate the feature replacement engine. The user will typically assume that the quick assistant is part of that third-party application. This increases the ease of use and acceptation of the new technology.

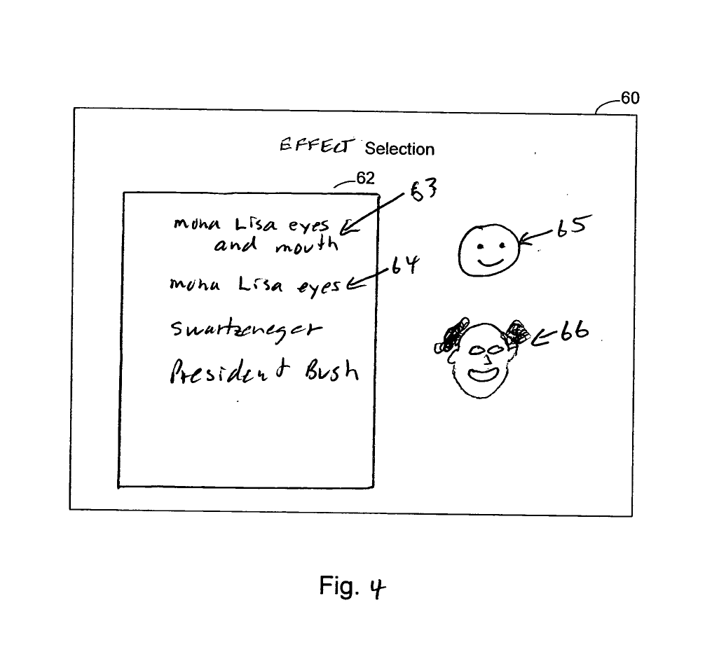

FIG. 3B illustrates a drop down menu 34 of the quick assistant dialog box 32. Examples of options are shown, others may be provided in other embodiments. The user can turn on or off face tracking, and can enable tracking of multiple faces. Face tracking may or may not be required for the feature recognition module. The user can click on the Video Effect Selection and another dialog box would appear, such as the examples set forth in FIG. 4. The menu can include options that are not part of the feature replacement features, but which a user may desire to modify at the same time, such as camera position. The options may allow the user to enable a video feature replacement effect, select an effect, or go to the Internet to download more effects.

### Effect Selection

FIG. 4 is a diagram of an embodiment of a user interface screen 60 for selecting particular expressions. A drop down menu 62 is provided. The user can select a particular one desired. For example, selection 63 is Mona Lisa with both eyes and mouth replaced, while selection 64 is Mona Lisa with only the eyes replaced. Rather than, or in addition to, word descriptions, icons or pictures could be used. Smiley face 65 and clown face 66 are examples. They can be combined with words saying which features are replaced, or the features to be replaced could be highlighted by bolding, using a different color, having them move, etc. For example, one smiling face could have the eyes moving, showing only the eyes will be replaced if it is selected. Another might have the eyes and mouth in red or bold, indicating that both the eyes and the mouth will be replaced if that icon or image is selected. The software then automatically applies the appropriate adjustments to the various features of the face.

Each feature selection has metadata associated with it that identifies the image in memory, which features are to be replaced, and the coordinates of those features in the image.

In one embodiment, rather than replacing a feature, a feature can be placed anywhere on the image. For example, the user's left eye or lips could be placed in the middle of Mona Lisa's forehead.

### Preview Screen

FIG. 5 illustrates one embodiment of a preview screen. An instant messenger window 70 and a video window 72 are shown. Next to them is the hovering dialog box, or quick assistant 32. A drop down menu 74 next to the quick assistant highlights the effect being displayed. In the example shown, a celebrity effect, “Mona Lisa,” is displayed, with the eyes and mouth of the user replacing the eyes and mouth of an image of Mona Lisa.

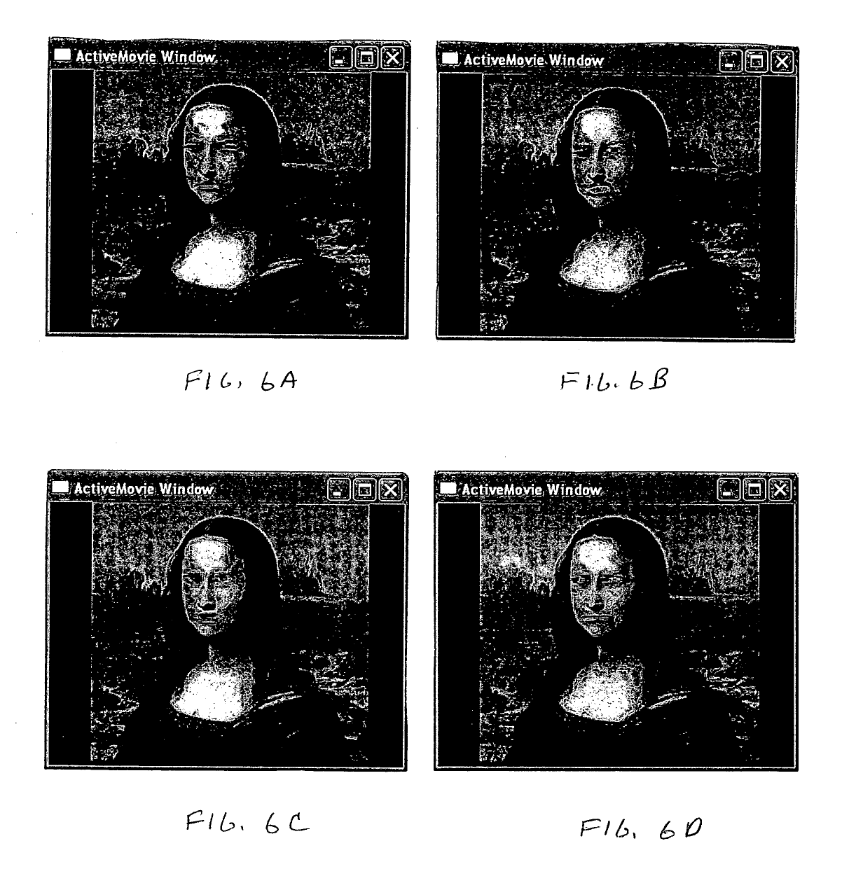

FIGS. 6A-6D are screen shots illustrating the modification of the eyes and mouth of Mona Lisa according to an embodiment of the invention.

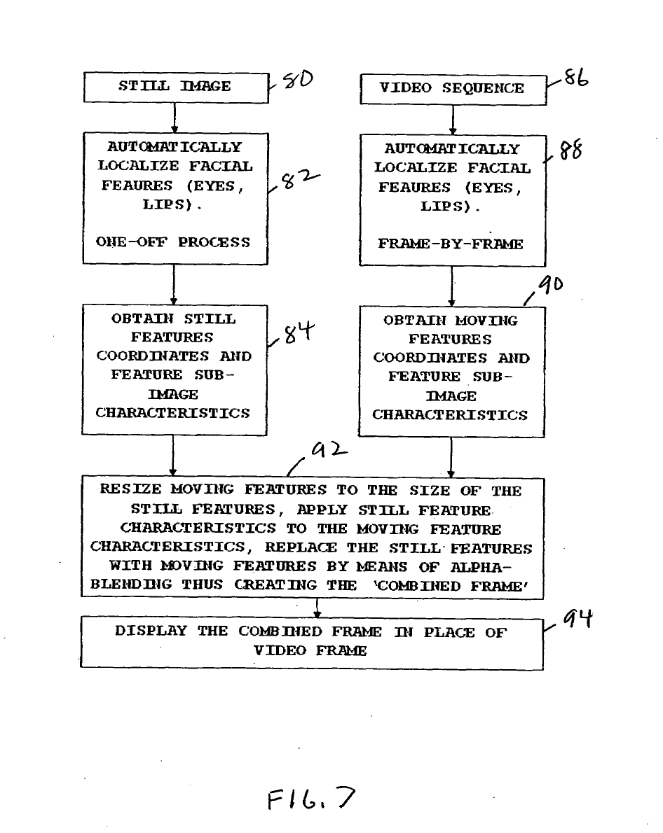

FIG. 7 is a flowchart of one embodiment of the invention, showing the processing of a still target image 80 (e.g., Mona Lisa) and a video sequence 86 from a webcam or other source. The target image 80 is processed and software localizes the facial features (e.g., eyes and lips). This is done once. The coordinates of the features are then extracted, along with sub-image characteristics (84).

For video sequence 86, the same localization process is done for each frame (88). The moving feature coordinates are obtained, along with feature sub-image characteristics. The moving features are then resized (92) to fit the size of the still, target image. The extracted features from the video are also re-oriented (e.g., tilted) as needed, and alpha blended with the characteristics of the still picture to produce a combined frame. Each combined frame is then displayed in place of the video frame (94).

### Variations

In one embodiment, the feature replacement applied to a face would move with the subject. In an embodiment of the present invention, the 3D position of the head and the features is localized and the replacement is adjusted from a frontal position to the actual position of the user. Thus, even if the face is not frontal, the feature replacement is maintained when the subject rotates his head so the lips or other feature would still look natural. This is accomplished with a 3D image being stored and modified for each feature, or with algorithms for adjustment in 3D on the fly being used.

In one embodiment, the present invention is able to apply the modifications to live video on the fly with a delay of less than one frame. This is possible because only certain (or all) facial features (or the entire face) are modified, not the entire frame. In one embodiment, less than 20% or less than 10% of the video is modified. This limits the amount of processing necessary and increases the speed at which the feature replacement can be done.

In another embodiment, the user selects the feature replacement to be applied before the video is fed to the application software program. In another embodiment, the user can also do the adjustments on the fly, feature replacement or changing the video image in the middle of an instant messenger conversation, for example.

In one embodiment, the invention is integrated into the video pipe so that it is transparent to any application program. The application program need not be modified to accommodate the present invention, which is applied at the driver level of the video feed.

In another embodiment, popular feature replacement combinations are stored. These are provided on a website which is accessible by users, and users can create their own and upload them to the website for sharing with other users.

In one embodiment, such as for a conference call with multiple people present, the feature replacement can be applied independently.

As will be understood as those of skill in the art, the present invention could be embodied in other specific forms without departing from the essential characteristics of the invention. For example, the feature replacement could be applied to features of the face of a pet, such as a dog, or any other image. The feature replacement module could also be made to appear upon initiation of an application program which uses still pictures, such as the sending of snapshots from a cell phone. The feature replacement engine could be made to appear anytime a video feed is requested by an application program, or only for certain types of application programs. The facial feature can also be the entire face. Accordingly, reference should be made to the appended claims which set forth the scope of the claimed invention.

What is claimed is:

1. A method for modifying an image, comprising:
receiving a source image of a person's face;
detecting at least a first facial feature from said source image;
extracting said first facial feature from said source image;
applying said first facial feature to a portion of a target image to produce a modified target image; and
providing said modified target image to an application program.

2. The method of claim 1 further comprising:
selecting a target image and at least said first facial feature by a user;
detecting a target facial feature in said target image corresponding to said first facial feature;
replacing said target facial feature with said first facial feature.

3. The method of claim 1 wherein said source image is a video image from a live video feed.

4. The method of claim 1 wherein said target image is a still image.

5. The method of claim 1 wherein said application program is an instant messaging program.

6. The method of claim 1 further comprising:
displaying a graphical user interface indicating the availability of said target image upon detection of said source image.

7. The method of claim 1 further comprising:
displaying a graphical user interface indicating the availability of said target image upon detection of said application program.

8. The method of claim 1 further comprising:
resizing said facial feature to fit within said target image; and
alpha blending said facial feature.

9. The method of claim 1 wherein said facial feature is an entire face.

10. The method of claim 1 wherein said facial feature is applied to other than the position of a corresponding facial feature in said target image.

11. An apparatus for modifying an image, comprising:
a video input feed including an image of a person's face;
a feature detection software module configured to detect a plurality of facial features from said video feed;
a feature replacement software module configured to receive an indication of detected facial features from said feature detection software and enable selection of at least a first one of said facial features, selection of a target image to which to apply said first facial feature and application of said first facial feature to a target image to produce a modified video feed; and
a modified video feed output directed to an application program.

12. The apparatus of claim 11 wherein said video input feed is a live video feed.

13. The apparatus of claim 11 wherein said feature replacement software module modifies less than 20 percent of said video input feed.

14. The apparatus of claim 11 further comprising a quick assistant for accessing said feature replacement software module.

15. The apparatus of claim 14 wherein said quick assistant is configured to hover near said application program using said video feed.

16. The apparatus of claim 11 further comprising:
a resizing module for resizing said facial feature to fit within said target image; and
an alpha blending module for alpha blending said facial feature.

17. An apparatus for modifying a video image, comprising:
a live video input feed including an image of a person's face;
a feature detection software module configured to detect a plurality of facial features from said video feed;
a feature replacement software module configured to receive an indication of detected facial features from said feature detection software and enable selection of at least a first one of said facial features, selection of a modification for said first facial feature and application of said modification to a target image to produce a modified video feed;
said feature replacement software module including resizing and alpha blending modules;
wherein said feature replacement software module modifies less than 20 percent of said target image;
a quick assistant for accessing said feature replacement software, said quick assistant being configured to hover near an application program using said video feed; and
a modified video feed output directed to said application program.

18. An system for modifying an image, comprising:
a video camera providing a video input feed including an image of a person's face; and
a computer including
a feature detection software module configured to detect a plurality of facial features from said video feed;
a feature replacement software module configured to receive an indication of detected facial features from said feature detection software and enable selection of at least a first one of said facial features, selection of a target image to which to apply said first facial feature and application of said first facial feature to a target image to produce a modified video feed; and
a modified video feed output directed to an application program.
